(19) United States
(12) Patent Application Publication
(10) Pub. No.: US 2021/0148660 A1
(43) Pub. Date: May 20, 2021

(54) INTERCOOLER ASSEMBLY

(71) Applicants: HYUNDAI MOTOR COMPANY, Seoul (KR); KIA MOTORS CORPORATION, Seoul (KR)

(72) Inventors: Seung Jae KANG, Seoul (KR); Hyun Jin PARK, Incheon (KR); Won Rok CHOI, Seoul (KR)

(73) Assignees: HYUNDAI MOTOR COMPANY, Seoul (KR); KIA MOTORS CORPORATION, Seoul (KR)

(21) Appl. No.: 16/860,620

(22) Filed: Apr. 28, 2020

(30) Foreign Application Priority Data
Nov. 19, 2019 (KR) 10-2019-0148927

(51) Int. Cl. F28F 27/02; F02B 29/04

(52) U.S. Cl. CPC F28F 27/02; F28F 2250/06; F02B 29/0418

(57) ABSTRACT

An intercooler assembly includes: a cooler main body having a heat exchange unit; an upper tank including an intake receiving portion connected to the heat exchange unit, and coupled to an upper portion of the cooler main body; a lower tank including an intake discharge portion connected to the heat exchange unit, and coupled to an lower portion of the cooler main body; a bypass receiving portion connected to a valve mounting portion, and forming a passage partitioned separately from the intake receiving portion; a bypass line portion that is provided at an exterior of the cooler main body and includes: an inlet connected to the bypass receiving portion and an outlet connected to the intake discharge portion; and a valve unit connected to the intake receiving portion and the bypass receiving portion.

### CROSS-REFERENCE TO RELATED APPLICATION

This application claims priority to and the benefit of Korean Patent Application No. 10-2019-0148927, filed on Nov. 19, 2019, the entire contents of which are incorporated herein by reference.

### FIELD

The present disclosure relates so an intercooler assembly for a vehicle.

### BACKGROUND

The statements in this section merely provide background information related to the present disclosure and may not constitute prior art.

Generally, an engine system of a vehicle is equipped with an exhaust gas recirculation (EGR) apparatus to recirculate a portion of the exhaust gas back to the intake line of the engine system.

The exhaust gas recirculation apparatus may include a high-pressure EGR (HP-EGR) unit that recirculates the exhaust gas at an upstream side of a catalyst and a low-pressure EGR (LP-EGR) unit that recirculates the exhaust gas at a downstream side of the catalyst.

A turbo-charged engine system typically includes an intercooler that cools an intake air that is compressed by a turbocharger and the low-pressure EGR unit to recirculate the exhaust gas.

We have discovered that in such an intercooler, while the intake air is being cooled, condensed water may be generated due to cooling of saturated water vapor contained in the low-pressure EGR gas. The condensed water may accumulate on the flow path of the intake, and may block the flow of the intake air, thereby deteriorating intake efficiency of the intercooler and also deteriorating cooling efficiency of the intercooler by reducing a cooling area of the intercooler. Furthermore, the condensed water accumulated in the flow path of the intake may be frozen in a winter season, and may cause a crack or a damage of the intake path.

The above information disclosed in this Background section is only for enhancement of understanding of the background of the present disclosure and therefore it may contain information that does not form the prior art that is already known to a person of ordinary skill in the art.

### SUMMARY

The present disclosure provides an intercooler assembly having advantages of inhibiting or preventing freezing of condensed water in the intercooler, and capability of exhausting the condensed water.

An exemplary intercooler assembly includes: a cooler main body having a heat exchange unit; an upper tank including an intake receiving portion connected to the heat exchange unit, and coupled to an upper portion of the cooler main body; a lower tank including an intake discharge portion connected to the heat exchange unit, and coupled to an lower portion of the cooler main body; a bypass receiving portion connected to a valve mounting portion, and configured to form a passage partitioned separately from the intake receiving portion; a bypass line portion having an inlet and an outlet, and provided at an exterior of the cooler main body, where the inlet is connected to the bypass receiving portion, and the outlet is connected to the intake discharge portion; and a valve unit connected to the intake receiving portion and the bypass receiving portion, and configured to selectively transfer an intake air supplied from a turbocharger to the intake receiving portion and the bypass receiving portion.

The exemplary intercooler assembly may further include a condensed water collecting portion formed at a lowest side of the bypass line portion, and communicating with the intake discharge portion.

In a high temperature and high load condition, the valve unit may close the bypass receiving portion, and may open the intake receiving portion.

In a low temperature and low load condition, the valve unit may open the bypass receiving portion, and may close the intake receiving portion.

The valve unit may include: a valve housing including a main receiving portion and mounted on the valve mounting portion, the main receiving portion communicating with the intake receiving portion and the bypass receiving portion; and a valve body assembly installed to the valve housing, and selectively opening and closing the passage of the intake receiving portion and the bypass receiving portion by an operation of an actuator.

The valve housing may further include a first valve passage and a second valve passage respectively communicating with the main receiving portion.

The first valve passage may have a predetermined passage cross-section and may be connected to the intake receiving portion. The second valve passage may have a passage cross-section smaller than a passage cross-section of the first valve passage and may be connected to the bypass receiving portion.

An imaginary center axis of the first valve passage may be disposed closer to an imaginary center axis of the main receiving portion than to an imaginary center axis of the second valve passage.

The valve body assembly may include: a valve rotation shaft that transverses the first and second valve passages and is connected to the actuator; a first valve body fixedly installed on the valve rotation shaft in the first valve passage; and a second valve body fixedly installed on the valve rotation shaft in the second valve passage.

The first and second valve bodies may be circular flaps and fixed to the valve rotation shaft perpendicularly to each other.

In exemplary forms, in a low temperature low load condition at a cold starting in winter, the intake of the relatively high temperature is bypassed, the block of the condensed water frozen at the intake outlet side is melted by the intake air, and therefore, crack or damage of the intake flow path due to freezing of the condensed water may be prevented.

Other effects that may be obtained or are predicted by an exemplary form will be explicitly or implicitly described in a detailed description of the present disclosure. That is, various effects that are predicted according to an exemplary form will be described in the following detailed description.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating an exemplary engine system applicable with an intercooler assembly;

FIG. 2 and FIG. 3 are perspective views respectively illustrating an intercooler assembly;

FIG. 4 illustrates an upper tank applied to an intercooler assembly;

FIG. 5 illustrates a lower tank applied to an intercooler assembly;

FIG. 6 and FIG. 7 are partial cross-sectional schematic diagrams of an intercooler assembly;

FIG. 8 to FIG. 10 illustrate a valve unit applied to an intercooler assembly; and

FIG. 11 and FIG. 12 illustrate an operation of an intercooler assembly.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure will be described more fully hereinafter with reference to the accompanying drawings, in which exemplary forms of the present disclosure are shown. As those skilled in the art would realize, the described forms may be modified in various different ways, all without departing from the spirit or scope of the present disclosure.

In order to clarify the present disclosure, parts that are not connected to the description will be omitted, and the same elements or equivalents are referred to with the same reference numerals throughout the specification.

Also, the size and thickness of each element are arbitrarily shown in the drawings, but the present disclosure is not necessarily limited thereto, and in the drawings, the thickness of layers, films, panels, regions, etc., are exaggerated for clarity.

In addition, in the following description, dividing names of components into first, second, and the like is to divide the names because the names of the components are the same as each other and an order thereof is not particularly limited,

Unless explicitly described to the contrary, the word “comprise” and variations such as “comprises” or “comprising”, will be understood to imply the inclusion of stated elements but not the exclusion of any other elements.

Furthermore, each of terms, such as “ . . . unit”, “ . . . means”, “ . . . part”, and “ . . . member” described in the specification, mean a unit of a comprehensive element that performs at least one function or operation.

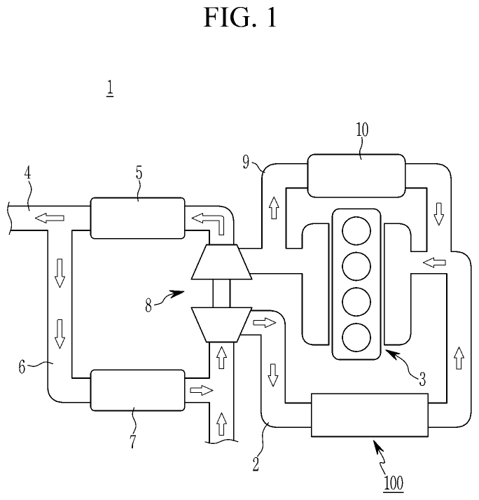

FIG. 1 is a block diagram illustrating an exemplary engine system applicable with an intercooler assembly according to an exemplary form of the present disclosure.

Referring to FIG. 1, an intercooler assembly 100 according to an exemplary form may be applied to an engine system 1 of a diesel engine vehicle.

For example, the engine system 1 includes: an intake line 2, an intercooler assembly 100, an engine 3, an exhaust line 4, a diesel particulate filter (DPF) 5, a low-pressure EGR line 6, a low-pressure EGR cooler 7, a turbocharger 8, a high-pressure EGR line 9, and a high-pressure EGR cooler 10.

The engine system 1 may recirculate a part of an exhaust gas exhausted from an exhaust manifold of the engine 3 through the exhaust line 4 back to the intake line 2. The intercooler assembly 100 may be applied to a low-pressure EGR (LP-EGR) system that recirculates the exhaust gas at a downstream side of the DPF 5 back to the intake line 2.

In the low-pressure EGR system, a portion of the exhaust gas having passed through the DPF 5 (low-pressure EGR gas) and fresh air may be supplied to the intake manifold of the engine 3 through the turbocharger 8.

Here, the intake air expands and the temperature increases as being compressed by the turbocharger 8, which causes the oxygen density to decrease. To improve this, the intercooler assembly 100 is installed in the intake line 2 to cool the intake air.

The intercooler assembly 100 cools (heat exchanges) the intake air supplied from the turbocharger 8 through intake line 2 and may supply the cooled intake air to the intake manifold of the engine 3.

Hereinafter, regarding a mounting position of the intercooler assembly 100, a portion facing upward with reference to the drawings is referred as to an upper portion, an upper end, an upper surface, or an upper end portion, and a portion facing downward is called as a lower part, a lower end, a lower surface, or a lower end portion.

However, the above definition of the directions has a relative meaning, and since the directions may vary according to a reference position of the intercooler assembly 100 and the like, the above-mentioned reference direction is not necessarily limiting a reference direction of the present disclosure.

In addition, hereinafter, an “end (one end, another end, and the like)” may be defined as any one end or may be defined as a portion (one end portion, another end portion, and the like) including that end.

In the intercooler assembly 100 according to an exemplary form, in a low temperature low load condition at a cold starting in winter, an intake air of a relatively high temperature is bypassed to an intake outlet side, and thereby a problem of condensed water freezing at the intake outlet side may be solved.

Furthermore, an exemplary form of the present disclosure provides an intercooler assembly 100 that is capable of easily exhausting condensed water accumulated in a lowest side.

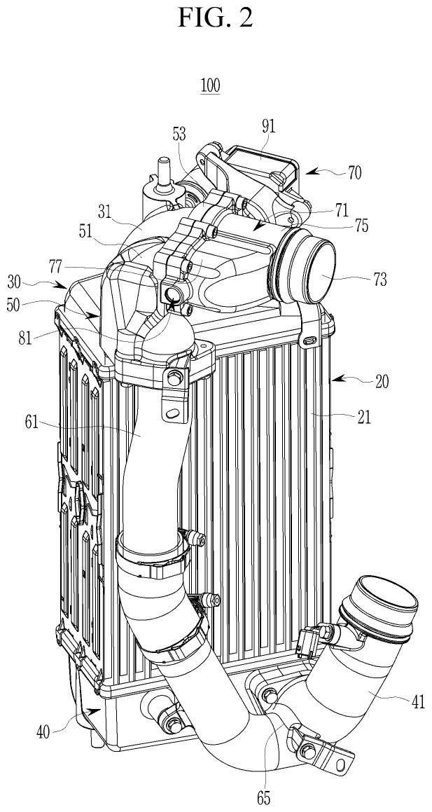

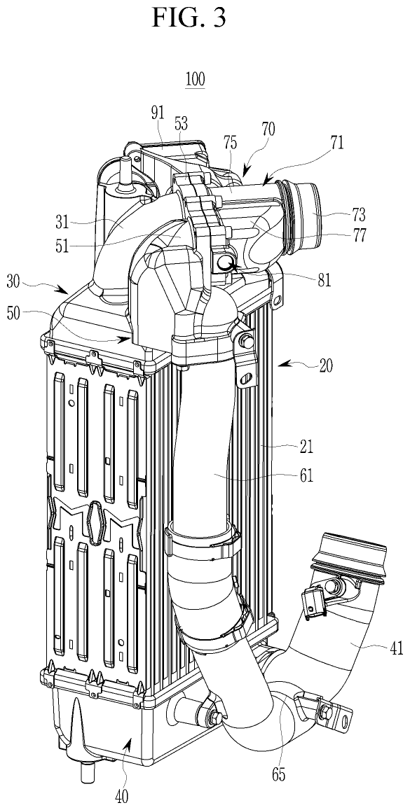

FIG. 2 and FIG. 3 are perspective views illustrating an intercooler assembly according to an exemplary form of the present disclosure.

Referring to FIG. 2 and FIG. 3, the intercooler assembly 100 includes a cooler main body 20, an upper tank 30, a lower tank 40, a bypass unit 50, and a valve unit 70.

In an exemplary form, the cooler main body 20 may include various accessory elements, such as a bracket, a plate, a collar, a block, a protrusion, a rib, or the like, to install various constituent elements.

The cooler main body 20 includes a heat exchange unit 21 for cooling the intake air while the intake air flows from an intake inlet side to an intake outlet side.

The heat exchange unit 21 may formed in a known scheme of a heat-exchanger, and is not described in further detail.

In an exemplary form, the upper tank 30 receives the intake air supplied from the turbocharger 8 (refer to FIG. 1), and supplies the received intake air to the heat exchange unit 21.

The upper tank 30 is coupled to an upper portion of the cooler main body 20. The upper tank 30 forms an interior space connected to an upper end of the heat exchange unit 21, and includes an intake receiving portion 31 connected to the heat exchange unit 21.

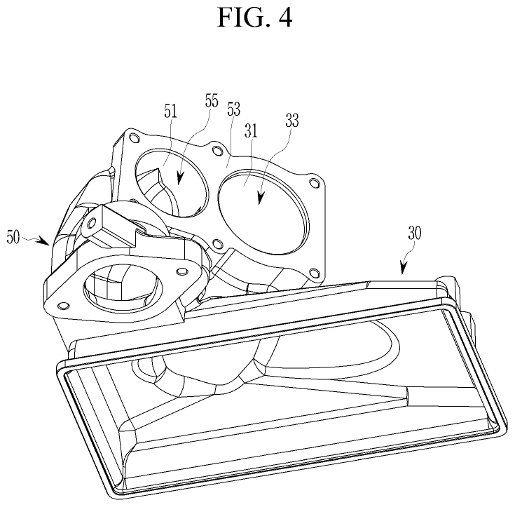

The intake receiving portion 31 transfers the intake air supplied from the turbocharger 8 to the heat exchange unit 21, and may be formed at an upper portion of the upper tank 30. As shown in FIG. 4, the intake receiving portion 31 forms an intake receiving passage 33 having a predetermined passage cross-section.

In an exemplary form, the lower tank 40 is to discharge, to the intake line 2 (refer to FIG. 1), the intake air that is cooled while flowing from the upper tank 30 through the heat exchange unit 21.

The lower tank 40 is coupled to a lower portion of the cooler main body 20. The lower tank 40 forms an interior space connected to a lower end of the heat exchange unit 21, and includes an intake discharge portion 41 connected to the heat exchange unit 21.

The intake discharge portion 41 may communicate with the interior space of the lower tank 40 in a lower portion of the lower tank 40. For example, the intake discharge portion 41 is provided in the form of a line, and disposed slanted upwardly from the lower portion of the lower tank 40.

In an exemplary form, the bypass unit 50 bypasses the intake air supplied from the turbocharger 8 to the upper tank 30 to the engine 3 through the intake discharge portion 41 without passing through the heat exchange unit 21 from the intake receiving portion 31.

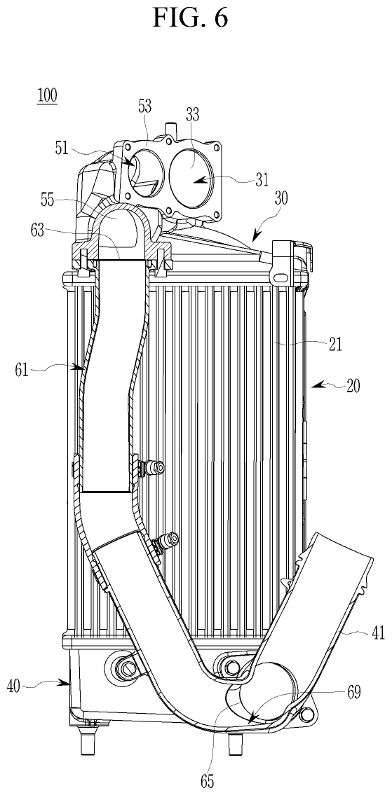

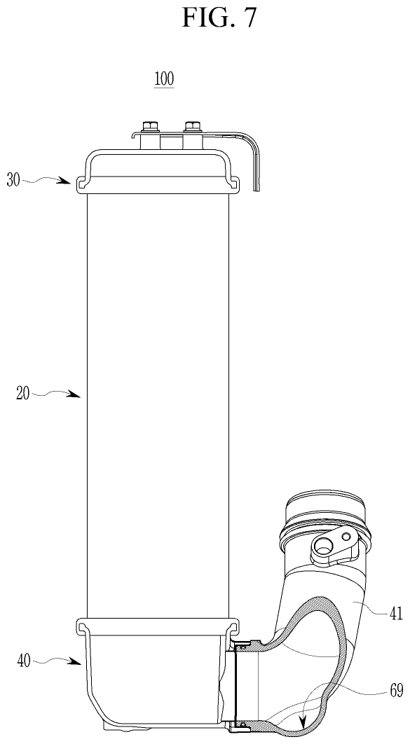

The bypass unit 50 includes a bypass receiving portion 51, a bypass line portion 61, and a condensed water collecting portion 69 (refer to FIG. 6 and FIG. 7).

As shown in FIG. 4, the bypass receiving portion 51 is connected to a valve mounting portion 53 at an exterior of the upper tank 30, and is provided in parallel with the intake receiving portion 31.

The bypass receiving portion 51 forms a bypass passage 55 partitioned separately from the intake receiving passage 33 of the intake receiving portion 31. That is, at the valve mounting portion 53, the intake receiving portion 31 is connected to the interior space of the upper tank 30 through the intake receiving passage 33. On the other hand, the bypass receiving portion 51 forms the bypass passage 55 connected to the bypass line portion 61 provided exterior to the upper tank 30.

Here, the bypass passage 55 of the bypass receiving portion 51 has a predetermined passage cross-section that is smaller than a passage cross-section of the intake receiving portion 31.

The bypass line portion 61 is to enable the intake air flowing into the bypass receiving portion 51 to bypass the heat exchange unit 21, and is provided at an exterior of the cooler main body 20.

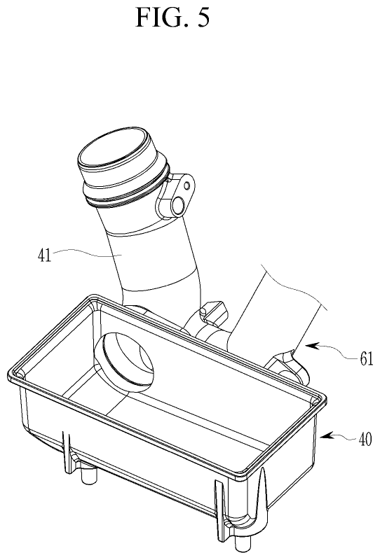

The bypass line portion 61 is connected to the bypass receiving portion 51 through an upper end, and as shown in FIG. 5, communicates with the lower tank 40 through a lower end.

In more detail, as shown in FIG. 6, the bypass line portion 61 is formed with an inlet 63 and an outlet 65 at the upper end and the lower end, respectively. The inlet 63 is connected to the bypass receiving portion 51 at a side of the upper tank 30. In addition, the outlet 65 is connected to the intake discharge portion 41 at a side of the lower tank 40.

In more detail, the outlet 65 of the bypass line portion 61 is integrally connected to the lower portion (or lower end) of the intake discharge portion 41 (refer to FIG. 2, FIG. 3, and FIG. 6).

In an exemplary form, as shown in FIG. 6 and FIG. 7, the condensed water collecting portion 69 is formed on a lowest side of the bypass line portion 61 and communicates with the intake discharge portion 41.

The condensed water collecting portion 69 may be formed at a connection portion of the bypass line portion 61 connected to the intake discharge portion 41, i.e., at a side of the outlet 65 of the bypass line portion 61.

The condensed water collecting portion 69 collects condensed water at a lowest side of the intercooler assembly 100, and may discharge the condensed water through the intake discharge portion 41.

Referring to FIG. 2 and FIG. 3, in an exemplary form, the valve unit 70 is to selectively transfer the intake air supplied from the turbocharger 8 to the intake receiving portion 31 and the bypass receiving portion 51 of the bypass unit 50.

Here, in a high temperature and high load condition, the valve unit 70 may close the bypass receiving portion 51 and open the intake receiving portion 31. In addition, in a low temperature and low load condition the valve unit 70 may open the bypass receiving portion 51 and close the intake receiving portion 31.

The high temperature/high load condition (also called a low flow amount/low pressure condition) means a normal driving condition of a vehicle. In addition, the low temperature/low load condition (also called a high flow amount/high pressure condition) means a cold start condition in winter.

Since the high temperature/high load condition and the low temperature/low load condition are clearly differentiable according to the condition of the vehicle, in an exemplary form, it is not necessary to differentiate the high temperature/high load condition and the low temperature/low load condition by a specific numeral ranges.

Configuration of sensors and controllers for determining the high temperature/high load condition and the low temperature/low load condition may be obvious to an ordinarily skilled person, and is not described in further detail.

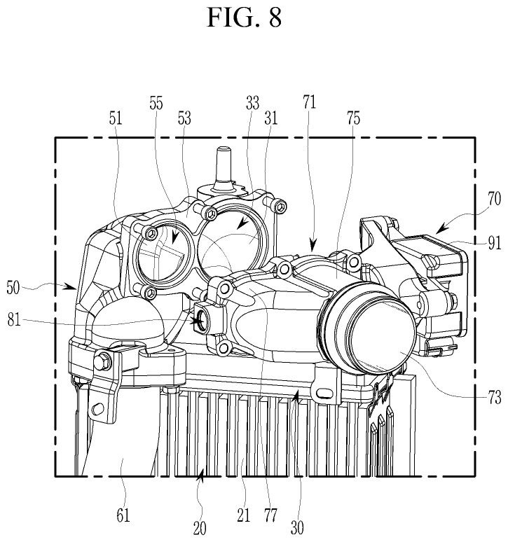

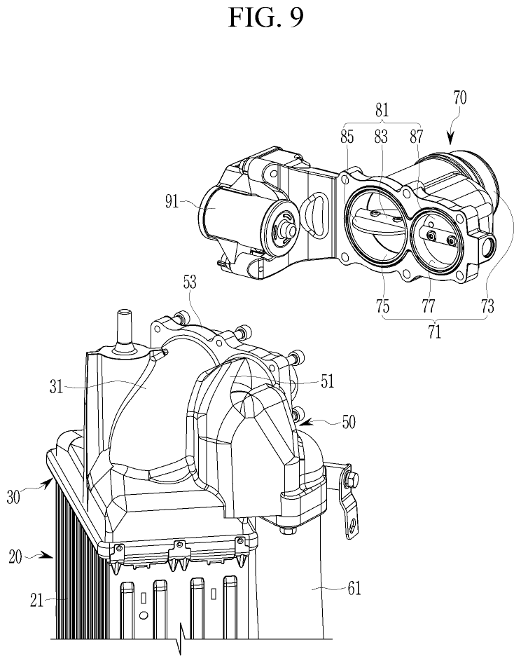

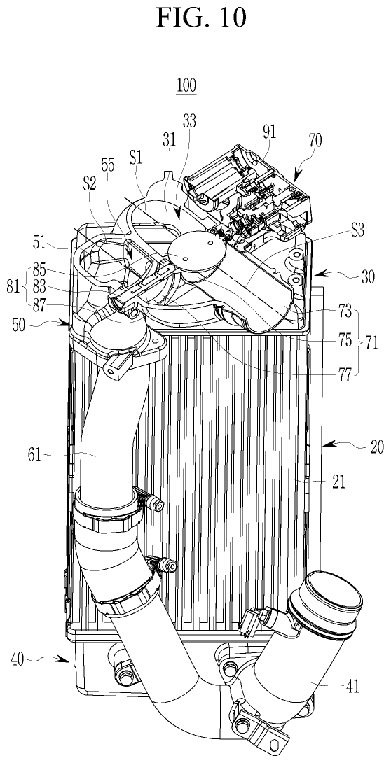

The valve unit 70 is installed to be connected to the intake receiving portion 31 and the bypass receiving portion 51. As shown in FIG. 8 to FIG. 10, the valve unit 70 includes a valve housing 71 and a valve body assembly 81.

The valve housing 71 is mounted on the valve mounting portion 53 forming the intake receiving portion 31 and the bypass receiving portion 51. The valve housing 71 forms a main receiving portion 73 that communicates with the intake receiving portion 31 and the bypass receiving portion 51. The main receiving portion 73 transfers the intake air supplied from the turbocharger 8 toward the intake receiving portion 31 and the bypass receiving portion 51.

The valve housing 71 includes a first valve passage 75 and a second valve passage 77 that are connected to the main receiving portion 73.

The first valve passage 75 has a predetermined passage cross-section, and connected to the intake receiving portion 31. The second valve passage 77 has another passage cross-section different from that of the first valve passage 75, and connected to the bypass receiving portion 51. For example, the second valve passage 77 has a passage cross-section that is smaller than the passage cross-section of the first valve passage 75.

Here, an imaginary center axis S1 of the first valve passage 75 is disposed closer to an imaginary center axis S3 of the main receiving portion 73 than to an imaginary center axis S2 of the second valve passage 77.

The valve body assembly 81 is to selectively open and close the intake receiving passage 33 of the intake receiving portion 31 and the bypass passage 55 of the bypass receiving portion 51, and is installed to the valve housing 71.

The valve body assembly 81 is driven by the operation of an actuator 91. The actuator 91 is installed in the valve housing 71. For example, the actuator 91 may include a known servomotor of capable of servo control of rotation speed and rotating direction by receiving an electrical control signal from a controller (not shown).

The valve body assembly 81 includes a valve rotation shaft 83, a first valve body 85, and a second valve body 87.

The valve rotation shaft 83 is a single shaft, installed in the valve housing 71 rotatably by the actuator 91. The valve rotation shaft 83 traverses the first and second valve passages 75 and 77, and is installed to be connected to the actuator 91.

The first valve body 85 is fixedly installed on the valve rotation shaft 83 in the first valve passage 75. In addition, the second valve body 87 is fixedly installed on the valve rotation shaft 83 in the second valve passage 77.

Here, the first and second valve bodies 85 and 87 may be circular flaps that respectively open and close the first and second valve passages 75 and 77, and are fixed on the valve rotation shaft 83 perpendicularly to each other.

Hereinafter, an operation of the intercooler assembly 100 according to an exemplary form is described in detail reference to accompanying drawings.

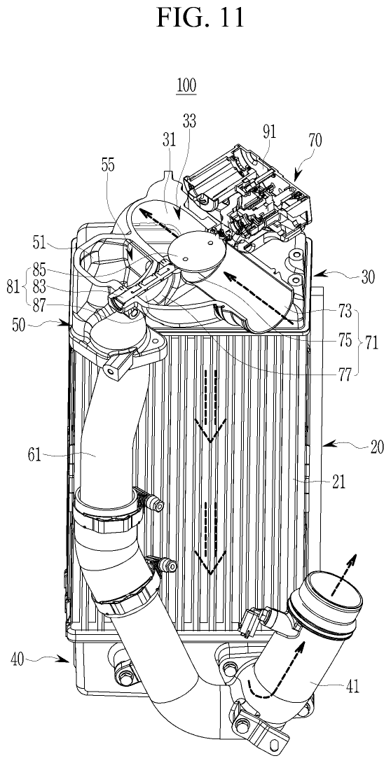

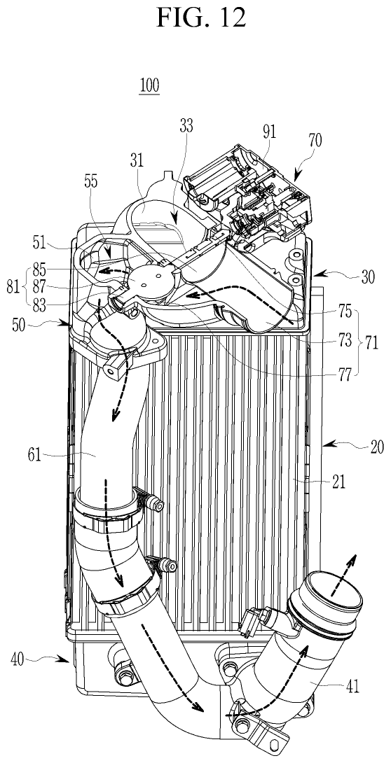

FIG. 11 and FIG. 12 illustrate an operation of an intercooler assembly according to an exemplary form of the present disclosure.

Referring to FIG. 11, in an exemplary form, in a high temperature high load condition of normal driving of a vehicle, by rotating the valve rotation shaft 83 according to an operation of the actuator 91 the first valve passage 75 is opened through the first valve body 85, and the second valve passage 77 is closed through the second valve body 87.

Accordingly, the intake receiving passage 33 of the intake receiving portion 31 communicates with the main receiving portion 73 through the first valve passage 75, and the bypass passage 55 of the bypass receiving portion 51 is closed by the second valve body 87.

In such a state, in an exemplary form, the low-pressure EGR gas and the fresh intake air (high temperature state) compressed at the turbocharger 8 flows into the main receiving portion 73 through the intake line 2.

Then, the intake air of the high temperature flows into the intake receiving passage 33 of the intake receiving portion 31 through the first valve passage 75, and flows into the heat exchange unit 21 through the interior space of the upper tank 30.

The intake air having flowed into the heat exchange unit 21 flows through a predetermined flow path of the heat exchange unit 21, and being cooled by exchanging heat, discharged through the intake discharge portion 41 of the interior space of the lower tank 40. The intake air discharged through the intake discharge portion 41 is supplied to the intake manifold of the engine 3 through the intake line 2.

In an exemplary form, the second valve passage 77 has a smaller passage cross-section than the first valve passage 75, and the imaginary center axis S1 of the first valve passage 75 is disposed closer to the imaginary center axis S3 of the main receiving portion 73 than to the imaginary center axis S2 of the second valve passage 77. Therefore, a load applied to the valve rotation shaft 83 through the second valve body 87 by the intake air may be reduced.

Furthermore, in an exemplary form, saturated water vapor contained in the low-pressure EGR included in the intake air gas may generate condensed water while being cooled. The condensed water is collected at the condensed water collecting portion 69 of the bypass line portion 61, and may be drawn into the intake line 2 through the intake discharge portion 41 by a boost pressure, thereby flowing into the intake manifold of the engine 3.

On the other hand, referring to FIG. 12, in an exemplary form, in a low temperature low load condition at a cold starting in winter, by rotating the valve rotation shaft 83 according to an operation of the actuator 91, the first valve passage 75 is closed through the first valve body 85, and the second valve passage 77 opened through the second valve body 87.

Accordingly, the intake receiving passage 33 of the intake receiving portion 31 is closed by the first valve body 85, and the bypass passage 55 of the bypass receiving portion 51 communicates with the main receiving portion 73 through the second valve passage 77.

In such a state, in an exemplary form, the low-pressure EGR gas and the fresh intake air compressed at the turbocharger 8 flows into the main receiving portion 73 through the intake line 2.

Then, the intake air of the relatively high temperature flows into the bypass passage 55 of the bypass receiving portion 51 through the second valve passage 77, and flows along the bypass line portion 61 to be discharged through the intake discharge portion 41. The intake air discharged through the intake discharge portion 41 is supplied to the intake manifold of the engine 3 through the intake line 2.

Therefore, in an exemplary form, in a low temperature low load condition at a cold starting in winter, an ice block of condensed water frozen at a discharge side of the intake is melted by the intake air of the relatively high temperature, and crack or damage of the intake flow path due to freezing of the condensed water may be prevented.

In an exemplary form, the second valve passage 77 has a smaller passage cross-section than the first valve passage 75, and the imaginary center axis S1 of the first valve passage 75 is disposed closer to the imaginary center axis S3 of the main receiving portion 73 than to the imaginary center axis S2 of the second valve passage 77. Therefore, a load applied to the valve rotation shaft 83 through the first valve body 85 by the intake air may be reduced.

On the other hand, in an exemplary form, in a low temperature low load condition, while bypassing the intake air through the bypass unit 50, the intake air including the low-pressure EGR gas may finely flow through a gap between the first valve body 85 and the first valve passage 75, and then into the heat exchange unit 21 through the intake receiving portion 31. In addition, the saturated water vapor contained in the low-pressure EGR gas may generate condensed water while being cooled.

The condensed water is collected at the condensed water collecting portion 69 of the bypass line portion 61, and may be drawn into the intake line 2 through the intake discharge portion 41 by a boost pressure, thereby flowing into the intake manifold of the engine 3.

Even if the condensed water collected at the condensed water collecting portion 69 is not flowed into the intake manifold of the engine 3 and thereby frozen at a low temperature low load condition, in an exemplary form, the ice block of the condensed water may be melted by the intake air of the relatively high temperature, and the melted condensed water may flow into the intake line 2 through the intake discharge portion 41.

According to the intercooler assembly 100 according to an exemplary form, in high temperature high load condition at normal driving of a vehicle, the intake air may be cooled while flowing into the heat exchange unit 21 by the operation of the valve unit 70.

In addition, in an exemplary form, in a low temperature low load condition at a cold starting in winter, by the operation of the valve unit 70, the intake air may be bypassed to the intake discharge portion 41 through the bypass unit 50.

Therefore, in an exemplary form, in a low temperature low load condition at a cold starting in winter, an increase of a differential pressure, deterioration of intercooler performance, a damage of the intake flow path, or the like, due to freezing of the condensed water may be prevented.

Furthermore, in an exemplary form, the condensed water generated in a high temperature high load condition and a low temperature low load condition is collected by the condensed water collecting portion 69 at a lowest side of the intercooler assembly 100, and is discharged to the intake line 2 through the intake discharge portion 41 by a boost pressure.

While this present disclosure has been described in connection with what is presently considered to be practical exemplary forms, it is to be understood that the present disclosure is not limited to the disclosed forms. On the contrary, it is intended to cover various modifications and equivalent arrangements included within the spirit and scope of the present disclosure.

<Description of symbols>

| | |
|---|---|
| 1: engine system | 2: intake line |
| 3: engine | 4: exhaust line |
| 5: DPF | 6: low-pressure EGR line |
| 7: low-pressure EGR cooler | 8: turbocharger |
| 9: high-pressure EGR line | 10: high-pressure EGR cooler |
| 20: cooler main body | 21: heat exchange unit |
| 30: upper tank | 31: intake receiving portion |
| 33: intake receiving passage | 40: lower tank |
| 41: intake discharge portion | 50: bypass unit |
| 51: bypass receiving portion | 53: valve mounting portion |
| 55: bypass passage | 61: bypass line portion |
| 63: inlet | 65: outlet |
| 69: condensed water collecting portion | 70: valve unit |
| 71: valve housing | 73: main receiving portion |
| 75: first valve passage | 77: second valve passage |
| 81: valve body assembly | 83: valve rotation shaft |
| 85: first valve body | 87: second valve body |
| 91: actuator | 100: intercooler assembly |

What is claimed is:

1. An intercooler assembly, comprising:
a cooler main body having a heat exchange unit;
an upper tank including an intake receiving portion connected to the heat exchange unit, and coupled to an upper portion of the cooler main body;
a lower tank including an intake discharge portion connected to the heat exchange unit, and coupled to an lower portion of the cooler main body;
a bypass receiving portion connected to a valve mounting portion, and configured to form a passage partitioned separately from the intake receiving portion;
a bypass line portion having an inlet and an outlet, and provided at an exterior of the cooler main body, the inlet being connected to the bypass receiving portion, the outlet being connected to the intake discharge portion; and
a valve unit connected to the intake receiving portion and the bypass receiving portion, and configured to selectively transfer an intake air supplied from a turbocharger to the intake receiving portion and the bypass receiving portion.

2. The intercooler assembly of claim 1, further comprising: a condensed water collecting portion formed at a lowest side of the bypass line portion, and configured to communicate with the intake discharge portion.

3. The intercooler assembly of claim 1, wherein:
in a high temperature and high load condition, the valve unit is configured to: close the bypass receiving portion, and open the intake receiving portion; and
in a low temperature and low load condition, the valve unit is configured to: open the bypass receiving portion, and close the intake receiving portion.

4. The intercooler assembly of claim 1, wherein the valve unit comprises:
a valve housing including a main receiving portion and mounted on the valve mounting portion, the main receiving portion configured to communicate with the intake receiving portion and the bypass receiving portion; and
a valve body assembly installed to the valve housing, and configured to selectively open and close the passage of the intake receiving portion and the bypass receiving portion by an operation of an actuator.

5. The intercooler assembly of claim 4, wherein the valve housing further comprises a first valve passage and a second valve passage configured to respectively communicate with the main receiving portion.

6. The intercooler assembly of claim 5, wherein:
the first valve passage has a predetermined passage cross-section and is connected to the intake receiving portion; and
the second valve passage has a passage cross-section smaller than a passage cross-section of the first valve passage and is connected to the bypass receiving portion.

7. The intercooler assembly of claim 6, wherein an imaginary center axis of the first valve passage is disposed closer to an imaginary center axis of the main receiving portion than to an imaginary center axis of the second valve passage.

8. The intercooler assembly of claim 5, wherein the valve body assembly comprises:
a valve rotation shaft configured to transverse the first and second valve passages and connected to the actuator;
a first valve body fixedly installed on the valve rotation shaft in the first valve passage; and
a second valve body fixedly installed on the valve rotation shaft in the second valve passage.

9. The intercooler assembly of claim 8, wherein the first and second valve bodies are circular flaps and fixed to the valve rotation shaft perpendicularly to each other.
